(19) United States
(12) Patent Application Publication
(10) Pub. No.: US 2014/0136472 A1
(43) Pub. Date: May 15, 2014

(54) Methodology supported business intelligence (BI) software and system

(71) Applicant: Erik Frafjord, Sandnes (NO)

(72) Inventor: Erik Frafjord, Sandnes (NO)

(73) Assignee: Bi-Builders AS, Sandnes (NO)

(21) Appl. No.: 14/117,856

(22) PCT Filed: May 23, 2013
(86) PCT No.: PCT/IB2013/054254

§ 371 Date: Nov. 15, 2013

Related U.S. Application Data
(60) Provisional application No. 61/650,738, filed on May 23, 2012.

(30) Foreign Application Priority Data
May 22, 2013 (IB) PCT/IB2013/054191

(51) Int. Cl. G06F 17/30

(52) U.S. Cl. CPC G06F 17/30563
USPC 707/602

(57) ABSTRACT

The invention provides idealized and reusable data source interfaces. The process of idealizing includes reengineering of the original data model using a surrogate key based model. The technique emphasizes readability and performance of the resulting operational data store.

The invention provides a unique method for handling changes that allows all types of changes to be automatically implemented in the operational data store by table conversion.

Further the invention provides Inline materialization that supports a continuous data flow dependency chain. The continuous dependency chain is used to provide automated documentation as well as dynamic paralleled transformation process.

Finally master data integration is provided as a benefit of architecture and the inbuilt surrogate key based data model. The feature implements integrations by specification rather than by programming.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of information management. More particularly, the present invention is in the technical field of BI. More particularly BI as defined by Forrester Research:

“BI is a set of methodologies, processes, architectures, and technologies that transform raw data into meaningful and useful information that's used to enable more effective strategic, tactical, and operational insights and decision-making.”

BI is today broadly recognized as the most vital mechanism for companies to provide strategic and operational meaningful information, reports and business figures from the company's many data sources.

The process of constructing an environment for BI is regarded as very complex and time consuming. In most cases it highlights both management and technical issues and can therefore be quite overwhelming, especially for medium and small size businesses.

The reason for this is that businesses are faced with, on one hand a large set of methodologies, architectures and “best practices” in the market, primarily in form of written books and documents, and on the other hand technologies in the area of ETL (Extract, Transform, Load) and visualization.

Businesses are left to use the available information and software components to build their own BI environment. This is a challenging task and more often than not leads to project failure in that it exceeds estimated cost, time and complexity. Moreover in these internal built BI solution environments there will normally be no reusability of data sources extractions, ETL processes or solutions across different companies in the market. This is due to the top-down and “silo” focus which makes generalization and reusability difficult.

ETL tools that exist in the market today are rich on functionality, but made for general purpose. The basic functionality has been around for many years, with limited development and innovation over the last years. Tools today are to a very limited extent supporting methodologies, architectures and today's “best practices” for BI.

Visualization tools on the other hand have shown a stunning development and innovation over the last few years, where the latest innovations have brought the market self-service BI, in-memory processing and animated visualizations.

It is a well-known fact in the industry that the cost and effort spent on ETL activities and visualization activities in a BI project is split near 80 to 20 percent respectfully. This makes it obvious where resources should be spent in order to reduce cost and risk in such projects.

### SUMMARY OF THE INVENTION

The present invention is a “methodology supported BI product”. The invention addresses several of the challenges with current technology and methodologies by
Idealizing the data source interfaces
Implementing Inline materialization services
Automated end-to-end dependency documentation
Master Data integration
   Thus making it possible for users to develop, maintain, and operate comprehensive BI environments “out-of-the-box”.

Moreover the invention provide users with features to handle all required changeability in their BI environments and to benefit from extensive reusability of idealized data source interfaces as well as ETL processes.

The invention relies on Microsoft operating systems and Microsoft SQL Server as the basic technology platform.

### BRIEF DESCRIPTION OF THE DRAWING

FIG. 1

Is an overview over the complete dataflow from source data to star schema construction included relevant data stores.

FIG. 2

Shows the physical database naming structure

FIG. 3

Is the products repository and usage by the product

FIG. 4

Shows the basic structure of handling data sources

FIG. 5

Shows the general database object naming conventions used throughout the product

FIG. 6

Shows the process of idealizing data sources

FIG. 7

Shows the extraction process

FIG. 8

Shows the dataflow from data source to staging area

FIG. 9

Shows the dataflow from staging area to the operational data store

FIG. 10

Shows the process of detecting changes between repository and the operational data store

FIG. 11

Shows the general transformation process with the operational data store as source

FIG. 12

Shows a more detailed transformation process using SQL views

FIG. 13

Shows the principle of inline materialization

FIG. 14

Shows overview of managed integration

FIG. 15

Shows the basic principle of a star schema

FIG. 16

Shows the principle of integrating different data sources against a common master data model

### DETAILED DESCRIPTION OF THE INVENTION

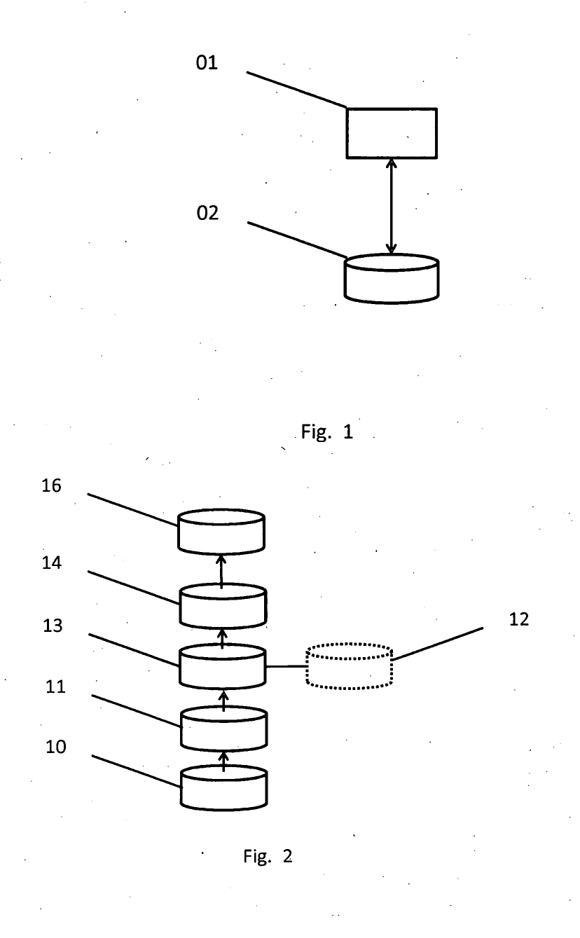

Referring now to the invention in more detail, FIG. 1 shows the general dataflow starting with data sources 10. It is important to notice that unlike 11-16 data sources 10 exists in as many instances as are relevant for a specific product installation.

11 is a physical database that is used as a data staging area. Full- or incremental loads from data sources 10 are bulk copied into the staging area to ensure maximum performance.

12 is a logical surrogate data area that physical resides in operational data store 13. The surrogate data area holds conversion tables that reflect the link between natural- and surrogate keys. For each table, the surrogate key is held in an integer column where the first record starts with the value 1 and is incremented by 1 for each new natural key. All data tables are assigned a surrogate key and surrogate keys are also used in foreign key references.

The operational data store 13 holds data tables with basically the same structure as the source data, but in a much more user friendly format.

The overall structure of a data table in operational data store 13 is:

| | | |
|---|---|---|
| Column | 1 | Primary key surrogate key |
| Column | 2 | Last Change Date |
| Column | 3 | Instance No |
| Column(s) | 4-n | Foreign surrogate keys if exists |
| Columns | n | Data columns |

To make sure that all relations are resolved in joins between tables, each data table has its own dummy record with primary key value set to 0. If foreign keys exist in this table, the surrogate foreign key columns value is also set to 0.

The ETL process is using the operational data store 13 as source and is carried out in the ETL database 14. The ETL process provides all relevant fact- and dimensions tables for the next level that is the star schema elements database 16.

The star schema database 16 is the level that interfaces with the visualization layer, either directly or via the data mart level 17. The sources tables and views resides in the ETL database 14 and is made available for star schema database 16 either by using views or by using the automated Stars schema modeler 15.

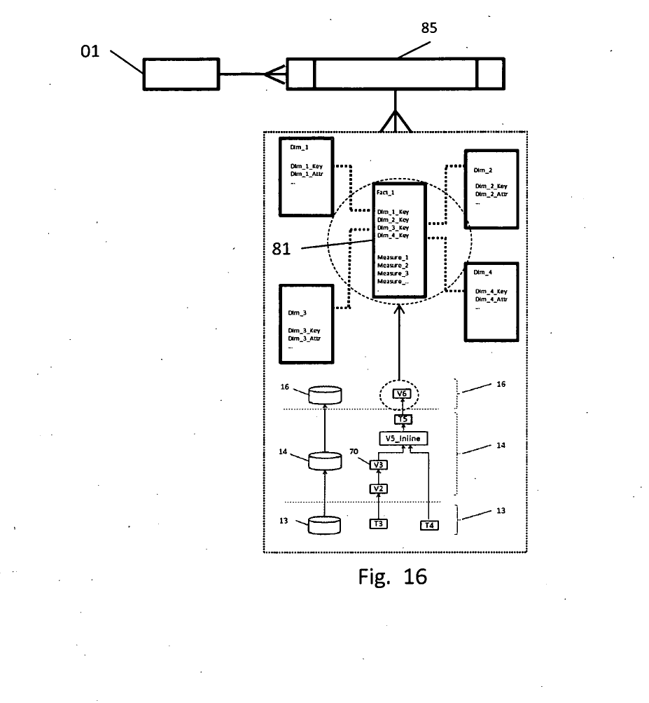

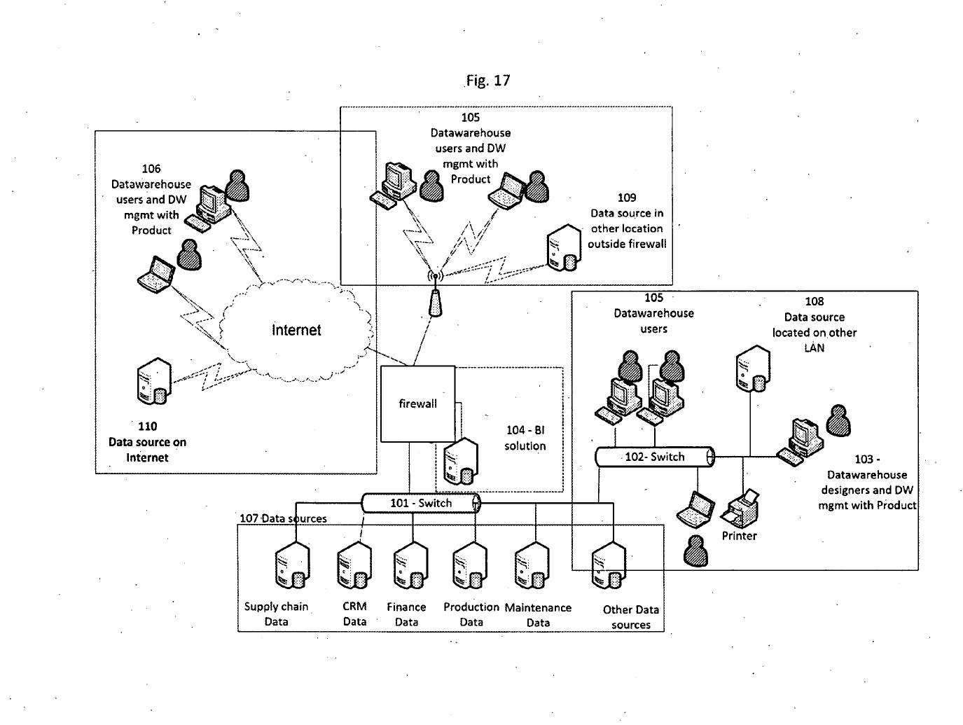

The Stars schema modeler 15 is a pure metadata database for defining fact- and dimension content and relationship. The Stars schema modeler 15 is an optional feature that allows for automated advanced configuration, integration and loading of different data sources. FIG. 16 shows how the stars schema modeler 15 is used conceptually and functionality will be detailed later in this document.

If the Stars schema modeler 15 is not used the star schema database 16 could be used manually by creating relevant views against the ETL database 14.

The data mart level 17 is optional and is used primarily to allow for customizing stars schemas for specific security purposes and/or specific user groups.

The data mart level 17 can exist in zero, 1 or many instances.

Referring now to FIG. 2 this shows the physical database naming conventions. The database name consists of two parts, a customizable prefix 20 and a fixed suffix 21. During the installation procedure the user is given the opportunity to specify his own prefix 20 or use a default prefix value.

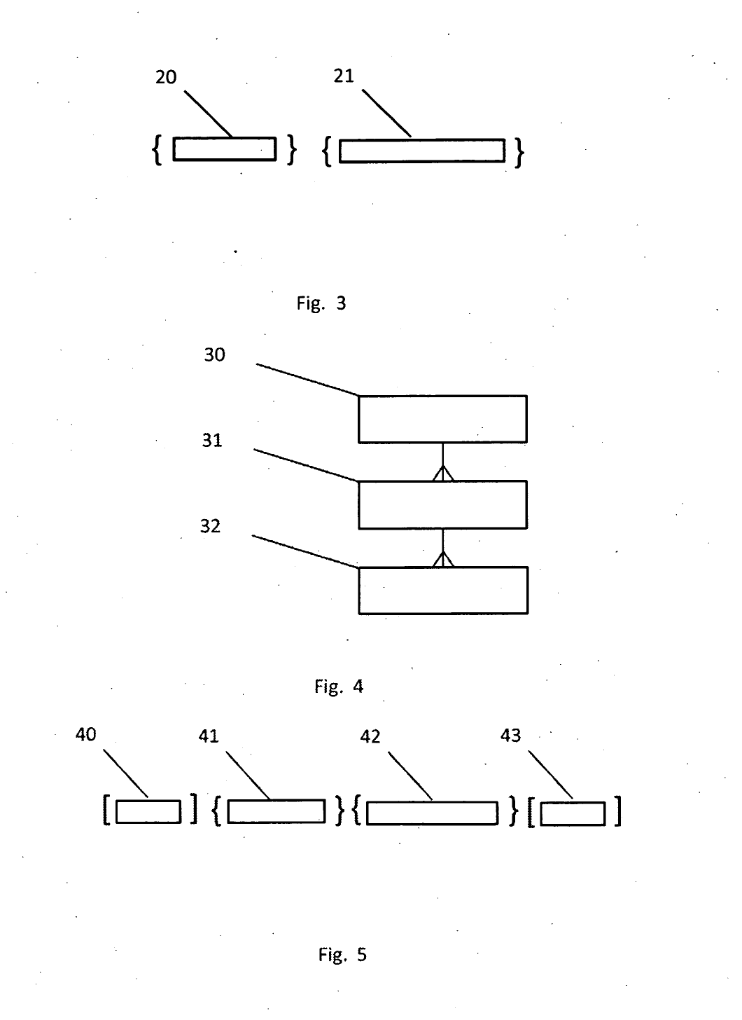

Referring now to FIG. 3 this shows how the product 01 is using its own repository database 02 for all persistent management information.

Referring now to FIG. 4 this shows the fundamental structure for handling data sources in the product. The data source level 30 serves solely as a logical grouping of data source versions 31. Data sources versions 31 contains specific database metadata information as well as mapping information that is used to implement friendly names for destination tables in the data warehouse. The data source version 31 can be used in one or more instances 32. This is to serve situations where a user has more than one instance of a source application installed or that he wish to handle logical different clients in a single application separately.

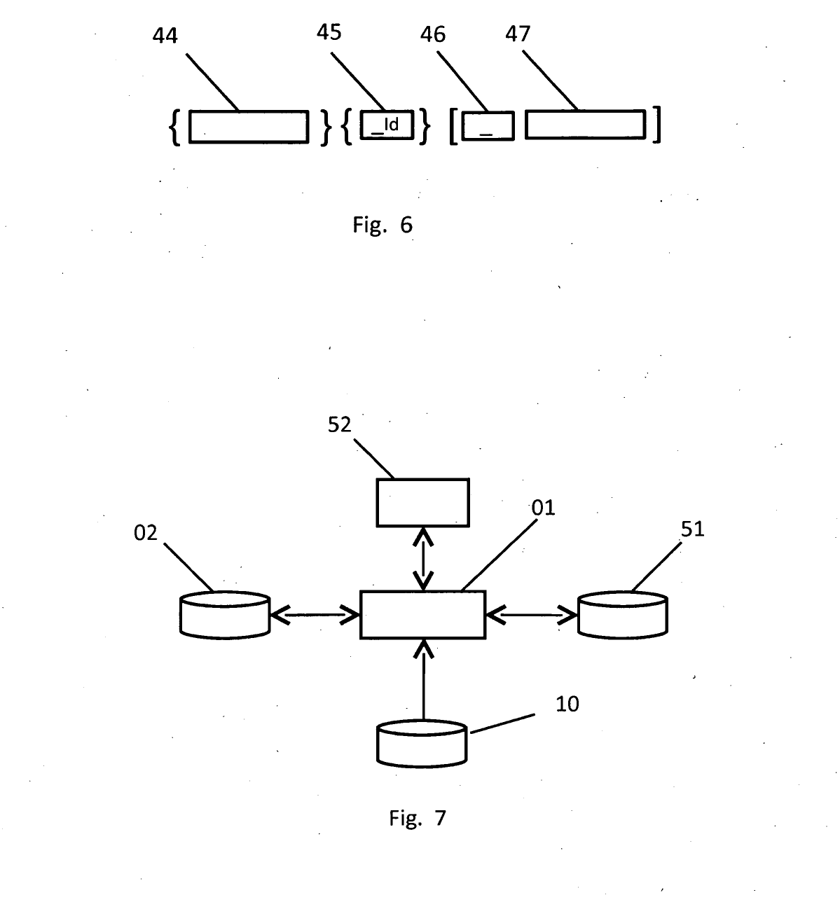

Referring now to FIG. 5 this shows object naming conventions and sequences (for objects on a lower level than database level) used by the product 01. The naming is divided into required and optional parts.

Starting with the required parts, the basic object name 42 is a free naming of the object. The instance identification 41 is a combined string that consists of the data source name, version id and instance id to easily identify data source and instance.

Optionally there might be a prefix 40 and a suffix 43 for allowing variation of basic objects for different purposes.

Referring now to FIG. 6 this shows the principle of idealizing data sources. Idealizing data sources are defined as the process of, regardless of the original data source, making the operational data model 13 as complete and understandable as possible. The fundamental requirements in the process are:
Provide intuitive table name mappings for relevant tables
Provide intuitive column name mappings for relevant columns
Complete the relational model with
   All primary keys
   All relevant foreign keys

The product 01 supports the process of idealizing data sources by the following step-by-step process chain.
1. Import the original data source 10 metadata into repository 02.
2. Provide intuitive table- and column names. The process is the act of mapping friendly names to the original names. This can be done by using internal editors in the product 01 or by allowing export and import of the complete metadata model to and from Excel 52.
3. In case the relational model is incomplete, the product support export of a complete metadata database 51 for a given data source 10. This metadata database 51 is then completed with necessary primary- and foreign keys using standard SQL Server Management Studio. After the completion the revised metadata database is imported into the repository 02.

The product 01 has now all necessary information to provide user friendly names in the operational data store 13, to create surrogate key and to visualize all relations in an intuitive manner.

Moreover the idealized data model now represents a reusable object that can be purchased as a commodity in a web shop 50 by users.

Referring now to FIG. 7 this shows an overview of the extraction process. It shows that the data flows from the data source 10, via the staging area 11 to the operational data store 13. The figure also show the surrogate data store 12 which is a part of the physical operational data store 13.

All necessary tables are automatically created after the following rules:
Staging data store 11
   Table is dropped and created if it exists, or created if it do not exists
   Table is dropped after successful execution or kept if execution was unsuccessful
Operational data store 13
   Surrogate data store 12
      Table is created if not exists
   Operational data store table
      Table is created if not exists

The load process is multithreaded, and the integrity of the process is ensured by making each table load dependent on that the specific table foreign key tables are successfully complete before loading.

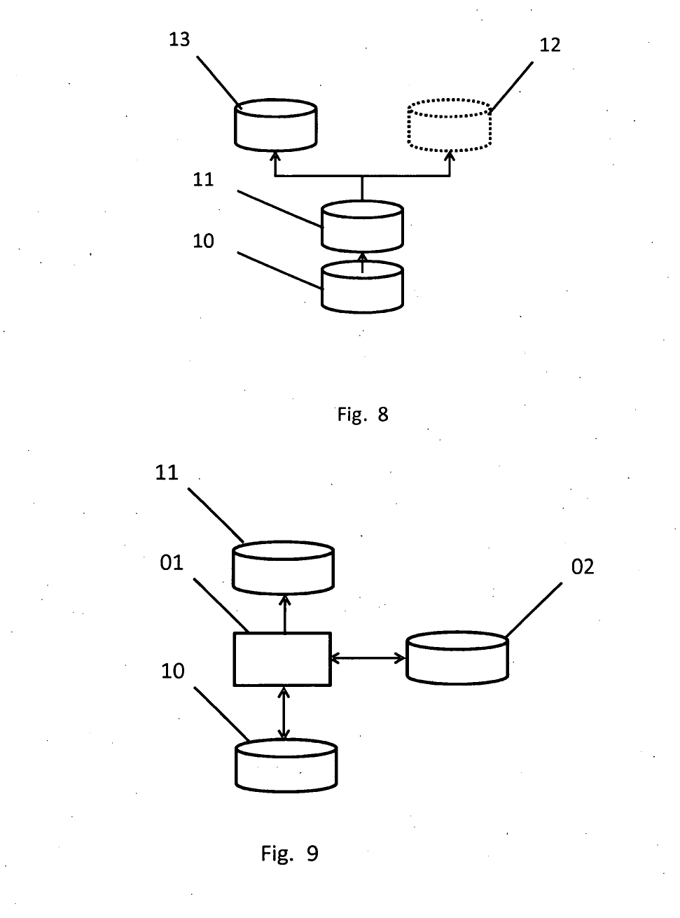

In further detail, referring to FIG. 8 shows how data flows between the data source 10 and the staging area 11.

The staging area 11 is used for full- or incremental load of data source tables 10. The structure mirrors the selected tables and columns from the data source 10. The product 01 supports a variety of selection criteria's:
Filter on specific column names through the complete data source 10 is used for filtering general codes like Client and language codes.
Specific filter(s) on specific tables
Incremental columns like a number, last update data etc.

The staging area tables are supplied with a primary key that is evaluated during the load process. This prevents duplicate records to be imported.

Referring now to FIG. 9, this shows the data flow between the staging data store 11 to the operational data store 12.

In this process several important functions are performed.

First and foremost the re-engineering of the destination data model takes place by converting all natural keys and foreign natural key references to integer surrogate keys 12.

All tables maintain their own surrogate key table 12 where natural keys are mapped to surrogate keys. A surrogate key table's primary key is the integer key, while the natural (one or more columns) forms a unique index.

During insert and update operations the surrogate tables are used to create and maintain surrogate keys for all data tables. If a specific natural foreign key do not have a corresponding natural key value in the surrogate table 11, the integer value zero is used as default value. The zero value will reference the dummy record that is implemented in the operational data store 13.

The data processing sequence is determined by the dependencies between tables. Dependency criteria in this setting are determined by foreign keys. This means that no table can be processed unless all tables that are used as foreign keys in the table have successfully updated their respective surrogate key tables first.

This ensures that all tables extracted from the specific data source 10 are in sync regarding relationships.

Still referring to FIG. 8, the data flow is basically handled in to different streams.
Update 54 if the record with actual surrogate primary key exists in the operational data store 13.
Load 53 if the record with actual surrogate primary key does not exists in the operational data store 13.

An extra feature for the update 54 stream is to optionally avoid updating if no involved column value in the update stream has actually been changed.

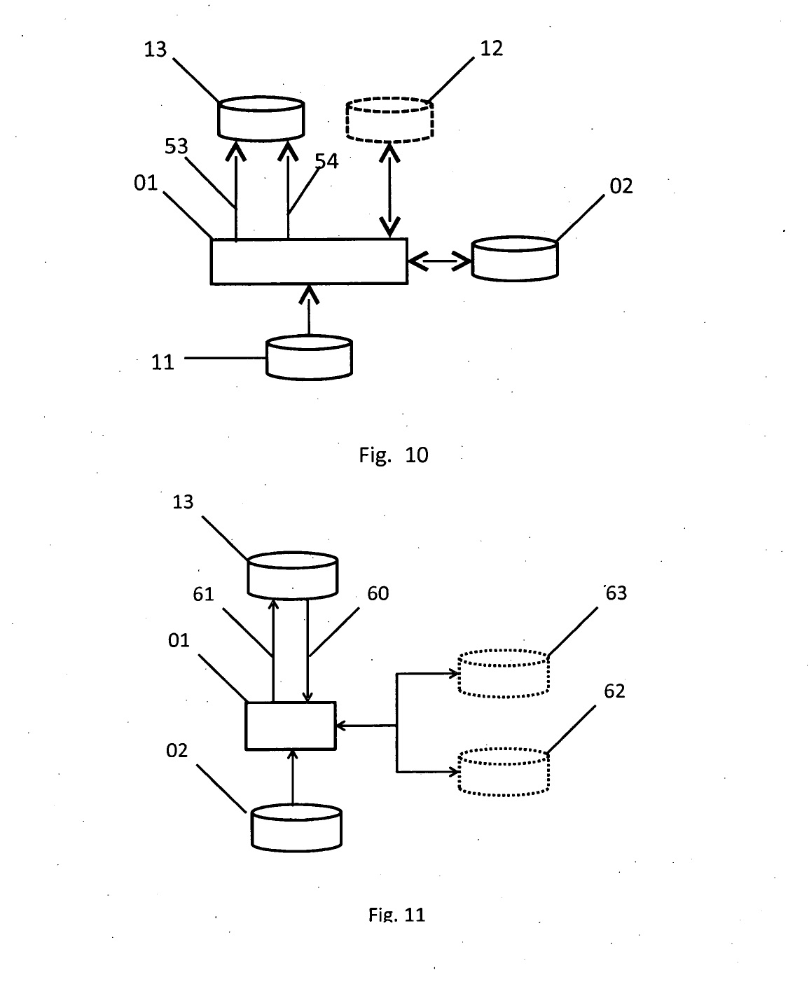

Referring now to FIG. 10 there is shown the principle for changeability. In a dynamic business world, new and changed requirements frequently occur. The data warehouse and BI solution must be able to comply with and adapt to these changes. Basically the product is designed to cope with all normal changes that occur:
New table
Dropped table
Renamed table
New column
Dropped column
Renamed column
New foreign key
Dropped foreign key
Altered data definitions

To be able to handle all the mentioned scenarios, it is necessary to implement a static reference model. This is because all normal references basically can be changed. The static reference model is established and maintained by using SQL Server extended properties in the operational data store 13 data tables.

On table level one extended property contains the data source 10 table names.

On column level one extended property per column is required, but with a bit more complex naming structure:
Primary surrogate key column gets the static value ‘PK’
Foreign surrogate key columns get the value of the correspondent external foreign key name
Ordinary columns gets the corresponding data source table 10 column name

The product 01 performs consistency check by comparing the repository 02 definitions with the operational data store 13 definitions. if any discrepancies are found a corrective script is built and optional executed by the product 01. This functionality enables the possibility of changing the data import dynamically without having a manual DWH overhead of reconstructing the data store.

In more detail the process consists of the following steps:
1. The product 01 extracts definitions from repository 02 and produces an intermediate internal table 62
2. The product 01 extracts definitions from the operational data store 60 and produces an intermediate internal table 63
3. The two tables 62 and 63 is then joined by using data source 10 definitions combined with the special case columns that is explained above.
4. Discrepancy script is created if any inconsistencies have been found.
5. The script is optionally executed 61.

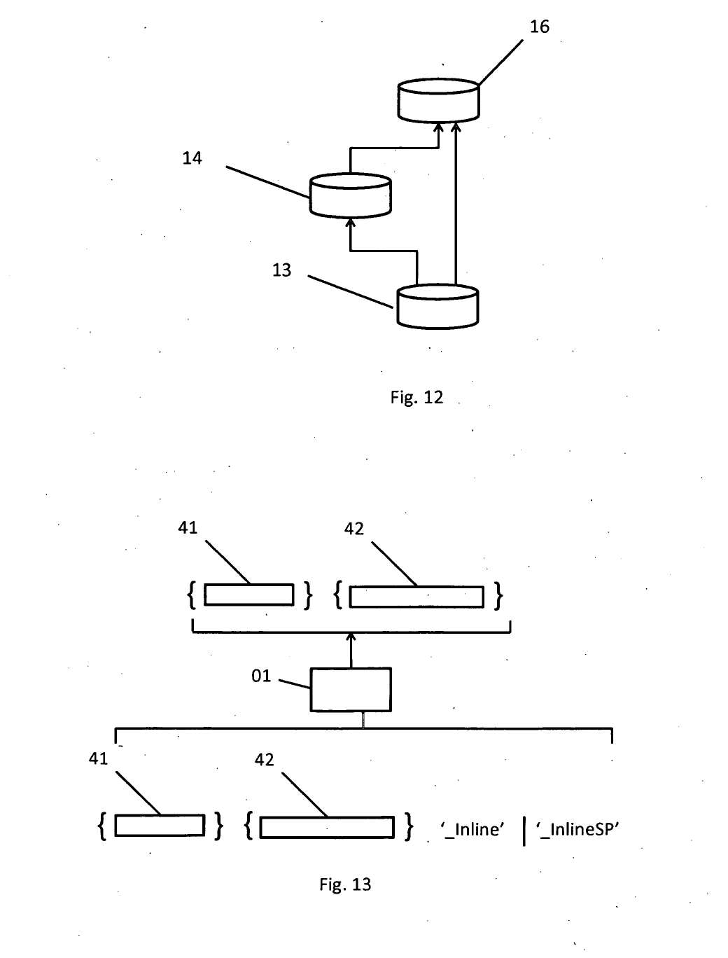

Referring now to FIG. 11 and FIG. 12 these shows the principle of transformation. Given the re-engineering of data source 10 in the operational data store 13, with consistent surrogate key based model, in many cases there will no need for transformations at all. Tables can serve directly as dimension- and fact tables in the star schema database 16.

If transformations are needed, the process could be viewed as series of dependent views in the ETL data store 14 that arc continuously refining the data into its ultimate dimension- or fact table in the star schema database 16. However, view dependency chains clearly have its limitations both when it comes to performance and also when very complex transformations are required.

The product 01 solves these issues by allowing specification of materialization (example 70). The specification requires only basic SQL Views. Moreover, the specification allow for activating Stored Procedures as well as basic SQL.

This simple mechanism ensures that all ETL processes are included in a manageable global unbroken dependency structure across databases in the BI solution.

The unbroken dependency chain is used for several purposes in the product 01:
1. An automated end-to-end dependency documentation.
2. An interactive visualization of dependencies for developers.
3. Dynamic multitasked, prioritized and parallelized execution of defined ETL tasks.

Referring now to FIG. 13 there is shown the detailed principle for materialization

When there is a need for materialization, a pre-defined naming convention and structure is used so that the Product recognizes the need for actions. It is done by providing a suffix that is either “_Inline” for materializing a view, or “_InlineSP” for materialization using a stored procedure. The output from both is a physical table that is named exactly like the “_Inline” view itself, but with the suffix removed. This technique allow for flexible materializations and de-materializations.

The following detailed rules apply to each type of materialization:

### “_Inline”

All materializations require a primary key specification. The specification of primary key is done by using the “order by” statement in the SQL view. All columns that are included in the “order by” statement will be regarded as primary key in the destination table definition.

Further, generation of a surrogate key can be enabled in 2 variations:
1. A zero value followed with an alias column name with the suffix “_Id_Ic” signals incremental load, meaning that only record with new primary key will be loaded. The alias column name “_Id_Ic” will be an identity column and renamed to “_Id_I” in the destination table definition.
2. A zero value followed with an alias column name with the suffix “_Id_Ix” signals that the table will be reloaded from scratch during every process. The alias column name “_Id_Ix” will be an identity column and renamed to “_Id_X” in the destination table definition.

The product 01 creates all destination tables in the ETL database 14. The product 01 also detects all structural changes between the view and the destination table. In such cases an optionally drop and recreate of the associated destination table is offered interactively.

### “_InlineSP”

Unlike materialization of a view “_InlineSP” signals a dummy view that only acts as a dependency structure placeholder.

There are several requirements for a stored procedure that is going to be used in a “_InlineSP” construct.

The stored procedure should accept and use the following default parameter values:
Database prefix 20—for database identification
Instance id 41—to allow usability across instances 32
Destination table name (automatically derived from view name)

In addition to the default parameters specified above, the store procedure might use its own specific parameters that then should follow the default ones.

The stored procedure view is constructed as follows:

| | | |
|---|---|---|
| Column | 1 | String containing the name of the stored procedure - any |
| | | alias column name |
| Column | 2 | String containing stored procedure specific parameter |
| | | list with values separated with comma - any alias |
| | | column name |

### EXAMPLE

| | |
|---|---|
| ‘MyProcedure’ | AS ProcedureName, |
| ‘MyParm1=”x”, ‘MyParm2=”y” ‘ | AS SpParm |

In order to make the dependency chain completed for stored procedures, the product 01 provides a facility to register the object names that the stored procedure is dependent on.

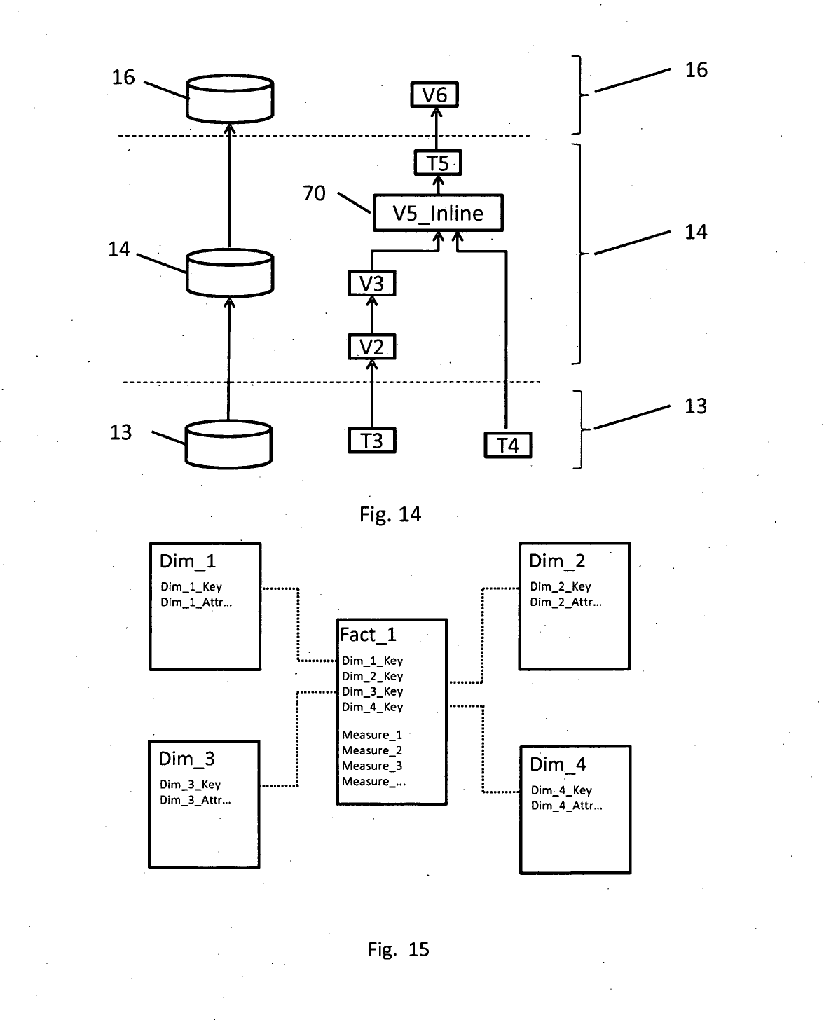

Referring now to FIG. 14 managed integrations overview, FIG. 15 Star Schema Sample and FIG. 15 a star schema sample.

Relevant integration scenarios that the product is designed to handle:
Integrate dimensions from different data sources against specific master data definition
integrate several instances 32 fact tables in a combined model

The Star Schema Database 16 is structured as the sample in FIG. 15—clusters of fact tables with related dimensions.

In the basic dataflow dimension identifications are data source instance related 32 up to the ETL database 14.

In scenarios where several data sources 10 are activated, there might be a requirement to integrate dimensions against master data definitions of its type. Most often one might find entities like users, vendors, services and products etc. as master data candidates, but also any other entity that are shared among data sources.

Referring now to FIG. 16 this shows the detailed principle of managed integrations.

The Star Schema Metadata database 15 contains a generic metadata definition of all fact- and its related dimension tables 42. The term generic is used here to point out that the names in this database 15 as well as the star schema database, does not contain an instance prefix 41.

The automated mapping between the ETL database 14 and the Star Schema Metadata database 15 is done by mapping names. For tables and views instance prefix 41 is excluded when comparing.

In this scenario there might be a one-to-many relationship between objects in the star schema metadata database 15 and the ETL database 14. The product offers a customization tool that allow selecting master data source 10 to integrate other dimensions against as well as combining multiple facts tables if they exist in different instances 32.

Based on the rules specified here, the product 01 automatically populates the star schema database 16.

The master data integrations are handled in two separate variations:
1. All sources 10 are already integrated against a master data regime by having the same natural key. The conversion of surrogate key is then performed by using surrogate tables 12 for the dimensions involved.
2. Sources 10 are not integrated on natural key level. Then the conversion needs a manually supplied conversion table that is managed in the product 01. Manage in this scenario means to be able to supply conversion values and to be notified when there are missing values in the conversion table.

1. A method of transforming raw electronic data which is stored in a first application data model into a second data model and loading data into said second data model, said method comprising the steps of:
(i) defining an idealized data model for at least one data source, said defining step comprising:
importing metadata from said data source into a product;
refining data model keys and relationships in said product if necessary; and
improving and/or selecting one or more new table- and column-names capable of defining said data source; and
(ii) processing an idealized data model for at least one data source by converting a first data model into a second relational data model, said processing step comprising:
converting one or more original data source keys and relationships to a surrogate key-based model by creating at least one destination table with an idealized name format;
creating a surrogate key conversion table for each destination table; and
importing data through a parallel processing of said destination tables.

2. The method of claim 1, wherein said importing of metadata further comprises an importing of tables, table names, column names, keys and relationships if information exists in a DBMS system.

3. The method of claim 1, wherein said importing of metadata further comprises an importing of table and column descriptions, key and relationship definitions if information exists in a data source application repository.

4. The method of claim 1, wherein said refining of data model keys and relationships further comprises an exporting of said data model to an empty metadata database, maintaining said data model definition using one or more standard DBMS features in creating a refined metadata model, importing said refined metadata model into a product again, and wherein each of said refining steps is capable of being performed as an iterative process and at any time.

5. The method of claim 1, wherein said improving and/or selecting of new table- and column-names further comprises
an editing of names directly in the product or exporting table and column definitions into an external standardized format,
maintaining said table and column names in said external standardized format,
importing said definitions into product again, and wherein each of said improving and/or selecting steps is capable of being performed as an iterative process and at any time.

6. The method of claim 1, wherein said creating of said at least one destination table further comprises selecting an idealized table name that is prefixed by a data source name, version number and instance number automatically defined in said product, and one or more idealized column names.

7. The method of claim 6, wherein said one or more idealized column names further comprises a primary key column which is a surrogate key column inheriting its name from said idealized table name and comprising a data type integer, a foreign key column which is a foreign surrogate key column inheriting its name from said related table name and comprising a data type integer, and if more than one reference is associated with the same table, a suffix comprising original foreign key column(s) having said defined idealized column name.

8. The method of claim 1, wherein said creating of a surrogate key conversion table for each data table further comprises idealizing a table name with a defined naming structure to separate it from each of said data tables and selecting an idealized column name having a surrogate key column name inheriting its name from said idealized table name and which comprises a integer and an original key column inheriting its name from said defined idealized column name and which comprises a data type from said data source.

9. The method of claim 1, wherein said importing of data through a parallel processing further comprises
dividing a data stream into an insert- and/or an update-stream,
executing data loads in a logical order as derived from said data model relationships, and
creating and/or updating surrogate key tables during a load process, each of said data tables dependent on a successful processing of its surrogate key tables and/or its tables that are referenced as a foreign key.

10. The method of claim 1, wherein said defining step further comprises the establishing of import filters and selection criteria from one or more or none of incremental rules for table load with or without overlapping records, one or more column level selection criteria for each table, global data source selection criteria and column level functions to manipulate data on row level.

11. A method of ensuring consistency between a configured product repository and a destination operational data store when changes to one or more configurations occurs, said method comprising the steps of:
creating and maintaining a static reference model further comprising a storing of object information in one or more object extended properties in said operational data store;
on a table level, at least one extended property containing a data source table;
on a column level, at least one extended property per column created using a primary surrogate key having a static standardized value, a foreign surrogate key having a value of a corresponding external foreign key name, and ordinary columns having a corresponding data source column name; and
comparing one or more repository configurations and definitions with one or more extended properties in said static reference model.

12. The method of claim 11, wherein said comparing of one or more repository configurations and definitions further comprises:
extracting definitions from said repository and producing a first intermediate internal table,
extracting definitions from said operational data store and producing a second intermediate internal table,
comparing said first and said second intermediate internal tables, creating a discrepancy script if inconsistencies are found, and displaying said discrepancies to a user along with a repair script that optionally can be executed.

13. A method of constructing an unbroken dependency chain for all data transformation tasks in a data warehouse, information management and/or business intelligence (hereinafter “a solution”) environment, said method comprising the steps of:
(i) establishing a naming format for database objects comprising one or more tables or views for a data transformation process, each of said tables or views includable in said unbroken dependency chain via naming and format standardization which can be specified in a product;
(ii) standardizing said solution environment by incorporating at least three standardized databases, a first database holding an idealized data source, a second database holding one or more transformation processes, a third database holding a multidimensional star diagram structure to be accessed by an end user visualization application;
(iii) creating said unbroken dependency chain by structuring and storing information in said standardized databases, wherein one or more physical dependencies are extracted from at least one DBMS system table into a dependency structure within said product, one or more dependencies that are derived from said standardized naming convention promoted by said product includable in said dependency structure within said product, said product enabling a defining of logical dependencies or relationships in said product and storage of said dependency structure within said product; and
(iv) defining and scheduling flexible update processes in said product by
using a dynamic unbroken dependency chain by defining logical dependencies on one or more top level objects within said multidimensional structure,
defining processing groups by using one or more fact table objects as input,
dynamically creating and maintaining a complete list of objects to be automatically included in an update process via said dependency structure, and
loading data by parallel processing of all objects on the same level in said dependency structure to automatically maximize performance efficiency.

14. The method of claim 13, wherein said step of establishing a naming format for database objects further comprises a deriving of a destination table name from said view name, a specifying a primary key column and an optional surrogate key column through said product or by a standardized format in database view, and an optional loading of full data or incremental data through said product or by a standardized format in database view.

15. The method of claim 13, wherein said database objects in said name establishing step further comprise one or more stored procedures, said one or more stored procedures having a view format comprising a destination table name and an associated view parameter, said one or more stored procedures being dynamically referable to said destination table and said associated view parameter.

16. The method of claim 13, wherein said one or more stored procedures is capable of being automatically loaded into said one or more tables.

17. A method to transform raw electronic data into meaningful and useful information, comprising:
idealizing metadata from at least one data source into a relational model, comprising,
importing metadata into a repository connected to a product,
generating intuitive table and column names by mapping a friendly name to an original name by the product,
refining the metadata to include table keys and relationships even if this information may not be accessible in the data source;
importing data from the at least one data source to a staging data store for temporary storage;
importing table(s) primary key(s) from the staging data store to a surrogate data store creating a surrogate key table, wherein the surrogate data store converts all original keys and foreign key references to surrogate keys, an original key being mapped to a surrogate key, the surrogate key table reflecting the link between the original and surrogate keys, wherein during insert and update operations the surrogate key tables are used to create and maintain surrogate keys;
processing the table for extraction to an operational data store, wherein the table can successfully update the surrogate key table before processing, the table being updated during processing if a record with an actual surrogate primary key exists in the operational data store, the table being loaded if a record with the actual surrogate primary key does not exist in the operational data store;
importing data to said operational data store, wherein the table has to successfully update the corresponding surrogate key table and the surrogate key table(s) of any related tables before processing; and
performing a consistency check on metadata level by comparing the repository with the operational data store.

18. The method of claim 17, wherein the idealizing step further comprises exporting a metadata database to provide primary and foreign keys using standard DBMS functionality, and wherein a revised metadata database is imported back into said repository where it can be iteratively refined one or more times, the relational model being a reusable object that can be purchased as a commodity.

19. The method of claim 17, wherein the idealizing step further comprises establishing user-crafted user-selected table name mappings and user-crafted user-selected column name mappings which can be set forth in an external spreadsheet exported by the system, the system disposed to read the spreadsheet and to bring about the associations with respect to the tables in response to the content of the spreadsheet.

20. The method of claim 17, wherein the check performing step further comprises creating a first intermediate internal table extracting data from the repository, creating a second intermediate internal table extracting data from the operational data store, joining the first and second intermediate internal tables, creating a discrepancy script if any inconsistencies are found, exporting the operational data store table directly to a star schema database if discrepancies are not found, and exporting the operational data store table to a ETL data store to refine the table and export the table to the star schema database if discrepancies are found.

21. A system for transforming raw electronic data which is stored in a first application data model into a second data model and loading data into said second data model, said system comprising:
an idealized data model for at least one data source, said idealized data model comprising imported metadata from said data source, refined data model keys and relationships, and one or more new table- and column names capable of defining said data source;
said idealized data model for at least one data source capable of converting a first data model into a second relational data model;
one or more original data source keys and relationships convertable to a surrogate key-based model through the creation of at least one destination table with an idealized name format;
at least one surrogate key conversion table for each destination table; and
data imported through a parallel processing of said destination tables.

22. The system of claim 21 further comprising an empty metadata database, capable of receiving exported data from said data model and maintaining a data model definition, a refined metadata model created from one or more standard DBMS features which can be imported into a system product, said refined metadata model capable of being generated iteratively.

23. The system of claim 21, wherein said at least one destination table further comprises an idealized table name that is prefixed by a data source name, version number and instance number automatically defined in a system product, and one or more idealized column names.

24. The system of claim 23, wherein said one or more idealized column names further comprises a primary key column which is a surrogate key column inheriting its name from said idealized table name and comprising a data type integer, a foreign key column which is a foreign surrogate key column inheriting its name from said related table name and comprising a data type integer, and if more than one reference is associated with the same table, a suffix comprising original foreign key column(s) having said defined idealized column name.

25. The system of claim 21, wherein said surrogate key conversion table for each data table further comprises a table name with a defined naming structure to separate it from each of said data tables and an idealized column name having a surrogate key column name inheriting its name from said idealized table name and which comprises a integer and an original key column inheriting its name from said defined idealized column name and which comprises a data type from said data source.

26. The system of claim 21 further comprising a data stream capable of being divided into an insert- and/or an update-stream and one or more data loads executable in a logical order as derived from said data model relationships.

27. The system of claim 21 further comprising import filters and selection criteria from one or more or none of incremental rules for table load with or without overlapping records, or from one or more column level selection criteria for each table, or from global data source selection criteria and column level functions to manipulate data on a row level.
